(19) United States
(12) Patent Application Publication
(10) Pub. No.: US 2006/0064684 A1
(43) Pub. Date: Mar. 23, 2006

(54) Method, apparatus and system to accelerate launch performance through automated application pinning

(76) Inventors: Robert J. Royer JR., Portland, OR (US); Sanjeev N. Trika, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/947,888

(22) Filed: Sep. 22, 2004

(51) Int. Cl. G06F 9/44

(52) U.S. Cl. 717/168

(57) ABSTRACT

In some embodiments, a method, apparatus and system to accelerate application launch performance through automated application pinning are presented. In this regard, a pinning agent is introduced to store data needed for the launch of an application in a memory, to periodically determine if the data has changed, and to replace the data if newer data is available. Other embodiments are also disclosed and claimed.

### FIELD OF THE INVENTION

Embodiments of the present invention generally relate to the field of disk caching, and, more particularly to a method, apparatus and system to accelerate application launch performance through automated application pinning.

### BACKGROUND OF THE INVENTION

Mass storage devices, like hard drives, generally have large capacities and are a comparatively cheap way to store application and data files. However, mass storage devices typically have slower access times and system performance is lowered when application and data files need to be accessed from a mass storage device as opposed to a higher speed memory device. Caching is a technique whereby a smaller faster memory stores some of the application and data files from the mass storage device that might be needed soon by a processor, thereby providing faster access to the cached files. Pinning is where particular contents of cache are stored and prevented from being evicted from cache despite a caching policy that might otherwise have evicted the contents.

### BRIEF DESCRIPTION OF THE DRAWINGS

The present invention is illustrated by way of example and not limitation in the figures of the accompanying drawings in which like references indicate similar elements, and in which:

FIG. 1 is a block diagram of an example electronic appliance suitable for implementing the pinning agent, in accordance with one example embodiment of the invention;

FIG. 2 is a block diagram of an example pinning agent architecture, in accordance with one example embodiment of the invention;

FIG. 3 is a flow chart of an example method for accelerating an application launch, in accordance with one example embodiment of the invention; and

FIG. 4 is a block diagram of an example article of manufacture including content which, when accessed by a device, causes the device to implement one or more aspects of one or more embodiment(s) of the invention.

### DETAILED DESCRIPTION

Embodiments of the present invention are generally directed to a method, apparatus and system to accelerate application launch performance through automated application pinning. In this regard, in accordance with but one example implementation of the broader teachings of the present invention, a pinning agent is introduced. In accordance with but one example embodiment, the pinning agent employs an innovative method to preserve and periodically update application launch data stored in a memory device. According to one example method, the pinning agent may periodically check for changes in the launch files, or portions thereof, or locations of the associated code and/or data on a mass storage device. According to another example method, the pinning agent may provide stored application launch data to a processor to accelerate the launch of the application. As used herein, an application launch includes system boots, automated startups, and plugin loadings, as well as user initiated application launches.

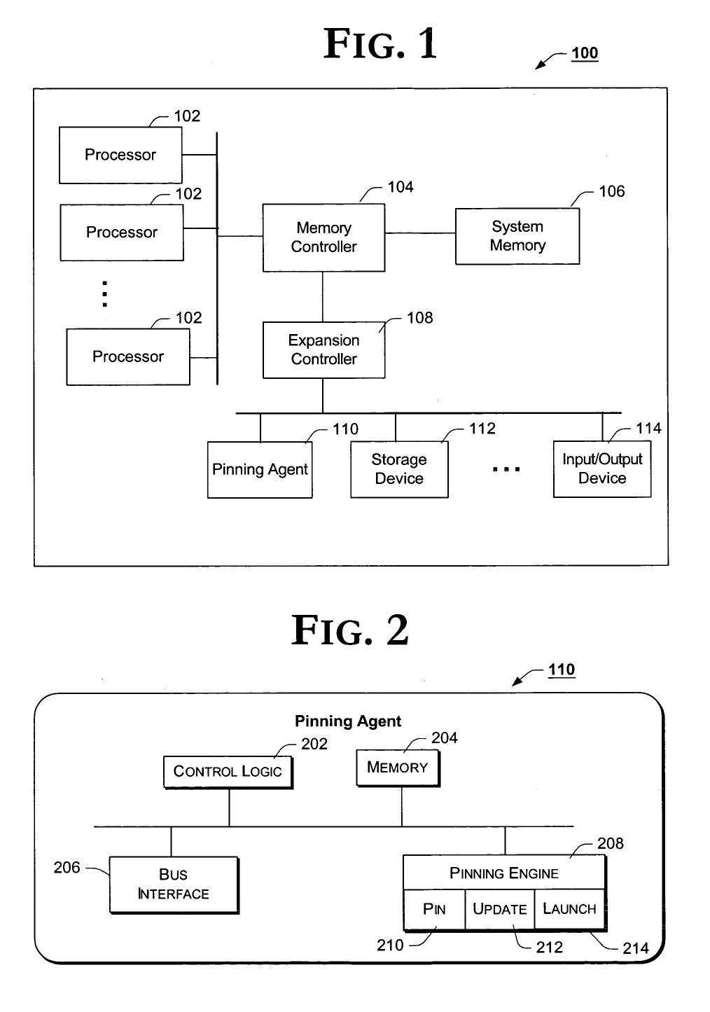

FIG. 1 is a block diagram of an example electronic appliance suitable for implementing the pinning agent, in accordance with one example embodiment of the invention. Electronic appliance 100 is intended to represent any of a wide variety of traditional and non-traditional electronic appliances, laptops, desktops, servers, disk drives, cell phones, wireless communication subscriber units, wireless communication telephony infrastructure elements, personal digital assistants, set-top boxes, or any electric appliance that would benefit from the teachings of the present invention. In accordance with the illustrated example embodiment, electronic appliance 100 may include one or more of processor(s) 102, memory controller 104, system memory 106, expansion controller 108, pinning agent 110, storage device 112 and input/output device 114 coupled as shown in FIG. 1. Pinning agent 110, as described more fully hereinafter, may well be used in electronic appliances of greater or lesser complexity than that depicted in FIG. 1. Also, the innovative attributes of pinning agent 110 as described more fully hereinafter may well be embodied in any combination of hardware and software.

Processor(s) 102 may represent any of a wide variety of control logic including, but not limited to one or more of a microprocessor, a programmable logic device (PLD), programmable logic array (PLA), application specific integrated circuit (ASIC), a microcontroller, and the like, although the present invention is not limited in this respect.

Memory controller 104 may represent any type of chipset or control logic that interfaces system memory 106 with the other components of electronic appliance 100. In one embodiment, the connection between processor(s) 102 and memory controller 104 may be referred to as a front-side bus. In another embodiment, memory controller 104 may be referred to as a north bridge.

System memory 106 may represent any type of memory device(s) used to store data and instructions that may have been or will be used by processor(s) 102. Typically, though the invention is not limited in this respect, system memory 106 will consist of dynamic random access memory (DRAM). In one embodiment, system memory 106 may consist of Rambus DRAM (RDRAM). In another embodiment, system memory 106 may consist of double data rate synchronous DRAM (DDRSDRAM). The present invention, however, is not limited to the examples of memory mentioned here.

Expansion controller 108 may represent any type of chipset or control logic that interfaces expansion devices with the other components of electronic appliance 100. In one embodiment, expansion controller 108 may be referred to as a south bridge. In one embodiment, expansion controller 108 complies with Peripheral Component Interconnect (PCI) Express Base Specification, Revision 1.0, PCI Special Interest Group, released Apr. 29, 2002.

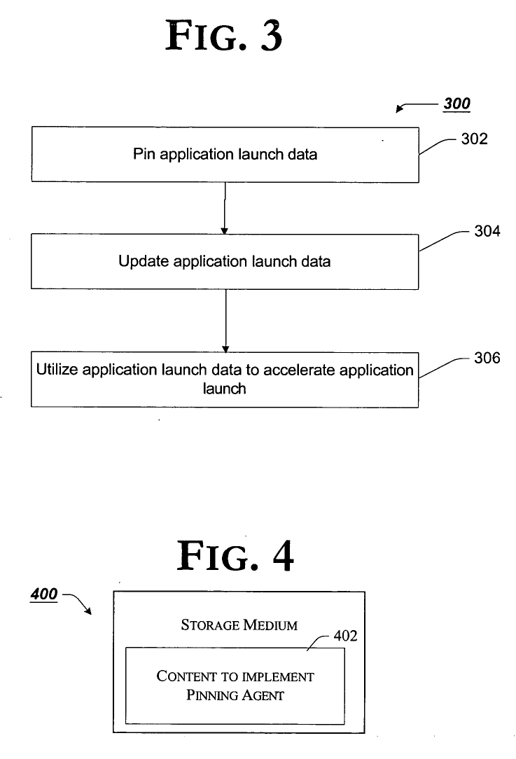

Pinning agent 110 may have an architecture as described in greater detail with reference to FIG. 2. Pinning agent 110 may also perform one or more methods to accelerate application launch, such as the method described in greater detail with reference to FIG. 3. While shown as being a separate component that interfaces with electronic appliance 100 through expansion controller 108, pinning agent 110 may well be part of another component, for example memory controller 104, or may be implemented in software or a combination of hardware and software.

Storage device 112 may represent any storage device used for the long term storage of data. In one embodiment, storage device 112 may be a hard disk drive.

Input/output (I/O) device 114 may represent any type of device, peripheral or component that provides input to or processes output from electronic appliance 100. In one embodiment, though the present invention is not so limited, at I/O device 114 may be a network interface controller.

FIG. 2 is a block diagram of an example pinning agent architecture, in accordance with one example embodiment of the invention. As shown, pinning agent 110 may include one or more of control logic 202, memory 204, bus interface 206, and pinning engine 208 coupled as shown in FIG. 2. In accordance with one aspect of the present invention, to be developed more fully below, pinning agent 110 may include a pinning engine 208 comprising one or more of pin services 210, update services 212, and/or launch services 214. It is to be appreciated that, although depicted as a number of disparate functional blocks, one or more of elements 202-214 may well be combined into one or more multi-functional blocks. Similarly, pinning engine 208 may well be practiced with fewer functional blocks, i.e., with only update services 212, without deviating from the spirit and scope of the present invention, and may well be implemented in hardware, software, firmware, or any combination thereof. In this regard, pinning agent 110 in general and pinning engine 208 in particular are merely illustrative of one example implementation of one aspect of the present invention. As used herein, pinning agent 110 may well be embodied in hardware, software, firmware and/or any combination thereof.

As introduced above, pinning agent 110 may have the ability to determine if application launch data pinned in a cache is current and to update the application launch data if necessary. In one embodiment, pinning agent 110 may determine if the starting disk address in storage device 112 of application launch files has changed. In another embodiment, pinning agent 110 may, in response to an indication of an application launch, provide stored data to processor(s) 102 to accelerate the launch of the application.

As used herein control logic 202 provides the logical interface between pinning agent 110 and its host electronic appliance 100. In this regard, control logic 202 may manage one or more aspects of pinning agent 110 to provide a communication interface from electronic appliance 100 to software, firmware and the like, e.g., instructions being executed by processor(s) 102.

According to one aspect of the present invention, though the claims are not so limited, control logic 202 may receive event indications such as, e.g., launch of an application. Upon receiving such an indication, control logic 202 may selectively invoke the resource(s) of pinning engine 208. As part of an example method to accelerate application launch, as explained in greater detail with reference to FIG. 3, control logic 202 may selectively invoke pin services 210 that may pin application files from storage device 112 into a memory. Control logic 202 also may selectively invoke update services 212 or launch services 214, as explained in greater detail with reference to FIG. 3, to update the pinned application files or provide pinned application files to processor(s) 102, respectively. As used herein, control logic 202 is intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. In some implementations, control logic 202 is intended to represent content (e.g., software instructions, etc.), which when executed implements the features of control logic 202 described herein.

Memory 204 is intended to represent any of a wide variety of memory devices and/or systems known in the art. According to one example implementation, though the claims are not so limited, memory 204 may well include volatile and non-volatile memory elements, possibly random access memory (RAM) and/or read only memory (ROM). Memory 204 may also include, among others: polymer memory, battery backed DRAM, RDRAM, NAND/NOR memory, flash memory, or Ovonics memory. In one embodiment, memory 204 may be a portion of system memory 106. In another embodiment, memory 204 may be part of a processor, system disk, or network cache. Memory 204 may be used to store one or more tables containing applications whose launches are to be accelerated as well as starting disk addresses for needed files. Memory 204 may also be used to store files needed to launch an application, such as executable and dynamic link library files, for example.

Bus interface 206 provides a path through which pinning agent 110 can communicate with other components of electronic appliance 100, for example storage device 112 or I/O device 114. In one embodiment, bus interface 206 may represent a PCI Express interface.

As introduced above, pinning engine 208 may be selectively invoked by control logic 202 to pin application launch files, data and/or code into memory, to update the pinned files, data and/or code, or to provide the pinned files, data and/or code as part of an application launch. In accordance with the illustrated example implementation of FIG. 2, pinning engine 208 is depicted comprising one or more of pin services 210, update services 212 and launch services 214. Although depicted as a number of disparate elements, those skilled in the art will appreciate that one or more elements 210-214 of pinning engine 208 may well be combined without deviating from the scope and spirit of the present invention.

Pin services 210, as introduced above, may provide pinning agent 110 with the ability to pin files, data and/or code needed to launch one or more applications in a memory. In one example embodiment, pin services 210 may determine which application launches to accelerate based on the frequency of previous application launches. In this way pin services 210 may automatically pin files needed for the launch of an application that has been launched previously. In another example embodiment, pin services 210 may pin files needed for the launch of applications that have been specified by a user, perhaps through an application interface. Pin services 210 may copy files to be pinned from a hard drive, i.e. storage device 112, or from a network drive, i.e. through I/O device 114, to memory. Pin services 210 may also pin a predetermined number of cache lines in processor(s) 102 internal cache, in response to an application launch. In one embodiment, pin services 210 copies files to be pinned into a non-volatile memory 204. In another embodiment, pin services 210 copies files to be pinned into volatile system memory 106 during a system boot.

Pin services 210 may also maintain a table of pinned files, data, code, associated applications, and/or starting addresses. In one embodiment, pin services 210 may maintain a pinned count for each pinned file to indicate how many, if any, applications would need a particular file in order to launch. In this way, any file in cache with a pinned count of one or greater would not be evicted from cache. In another embodiment, pin services 210 may maintain an application bit field for each application launch to be accelerated that identifies the files that are pinned corresponding to the application. In this way, any file in cache with one or more application bit fields set would not be evicted from cache.

As introduced above, update services 212 may provide pinning agent 110 with the ability to update pinned files, data and/or code. In one example embodiment, update services 212 may periodically verify that the contents or location of pinned files hasn't changed. In another example embodiment, update services 212 may verify that the starting address of pinned files hasn't changed after detecting a system change, such as a patch being loaded or a disk defrag being performed. Update services 212 may also have the ability to replace pinned files with new files when the starting address has changed, or if a determination is made to pin a different application.

Launch services 214, as introduced above, may provide pinning agent 110 with the ability to utilize pinned files, data and/or code to accelerate application launches. In one embodiment, launch services 214 may redirect an attempt to retrieve data from storage device 112 to memory 204, to the extent the requested contents are present there. In another example embodiment, launch services 214 may share the starting addresses of files pinned by pinning agent 110 with a driver or file system, so that system software may know which contents may be accessed through memory 204.

FIG. 3 is a flow chart of an example method for accelerating an application launch, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention.

According to but one example implementation, the method of FIG. 3 begins with control logic 202 selectively invoking pin services 210 to pin (302) application launch data. In one example embodiment, pin services 210 copies application launch data into memory 204 in response to a user request. In another example embodiment, pin services 210 increments a pinned count for the pinned application launch data.

Control logic 202 may then selectively invoke update services 212 to update (304) the application launch data, as appropriate. In one example embodiment, update services 212 may periodically determine if the starting disk address of the application launch data has changed. In another example embodiment, update services 212 may determine if the starting disk address of the application launch data has changed in response to a system event, such as, for example, if defrag is run.

Next, launch services 214 may utilize (306) the application launch data to accelerate an application launch. In one embodiment, launch services 214 may provide the application launch data to processor(s) 102 to accelerate the application launch in response to a request to launch the application. In another embodiment, launch services 214 may notify a file system of the contents of memory 204 which may be accessed at a later time.

FIG. 4 illustrates a block diagram of an example storage medium comprising content which, when accessed, causes an electronic appliance to implement one or more aspects of the pinning agent 110 and/or associated method 300. In this regard, storage medium 400 includes content 402 (e.g., instructions, data, or any combination thereof) which, when executed, causes the appliance to implement one or more aspects of pinning agent 110, described above.

The machine-readable (storage) medium 400 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem, radio or network connection).

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the present invention may be used in a variety of applications. Although the present invention is not limited in this respect, the invention disclosed herein may be used in microcontrollers, general-purpose microprocessors, Digital Signal Processors (DSPs), Reduced Instruction-Set Computing (RISC), Complex Instruction-Set Computing (CISC), among other electronic components. However, it should be understood that the scope of the present invention is not limited to these examples.

Embodiments of the present invention may also be included in integrated circuit blocks referred to as core memory, cache memory, or other types of memory that store electronic instructions to be executed by the microprocessor or store data that may be used in arithmetic operations. In general, an embodiment using multistage domino logic in accordance with the claimed subject matter may provide a benefit to microprocessors, and in particular, may be incorporated into an address decoder for a memory device. Note that the embodiments may be integrated into radio systems or hand-held portable devices, especially when devices depend on reduced power consumption. Thus, laptop computers, cellular radiotelephone communication systems, two-way radio communication systems, one-way pagers, two-way pagers, personal communication systems (PCS), personal digital assistants (PDA's), cameras and other products are intended to be included within the scope of the present invention.

The present invention includes various operations. The operations of the present invention may be performed by hardware components, or may be embodied in machine-executable content (e.g., instructions), which may be used to cause a general-purpose or special-purpose processor or logic circuits programmed with the instructions to perform the operations. Alternatively, the operations may be performed by a combination of hardware and software. Moreover, although the invention has been described in the context of a computing appliance, those skilled in the art will appreciate that such functionality may well be embodied in any of number of alternate embodiments such as, for example, integrated within a communication appliance (e.g., a cellular telephone).

Many of the methods are described in their most basic form but operations can be added to or deleted from any of the methods and information can be added or subtracted from any of the described messages without departing from the basic scope of the present invention. Any number of variations of the inventive concept is anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

What is claimed is:

1. A method comprising:
storing data needed for the launch of an application in a memory;
periodically determining if the data is current; and
replacing the stored data if more current data is available.

2. The method of claim 1, further comprising:
utilizing the stored data to accelerate the launch of the application.

3. The method of claim 2, further comprising:
automatically determining which application launch to accelerate based on the frequency of previous application launches.

4. The method of claim 2, further comprising:
determining which application launch to accelerate based on a user input.

5. The method of claim 2, further comprising:
pinning the stored application launch data to prevent the stored data from being overwritten.

6. The method of claim 2, wherein periodically determining if the data is current comprises:
determining if a starting disk address for the data has changed.

7. An electronic appliance, comprising:
a processor;
a cache memory coupled with the processor to store data needed for the launch of an application;
a storage device coupled with the cache memory; and
a pinning engine coupled with cache memory, the pinning engine to determine the data associated with the application to pin, the pinning engine to determine if the data stored in the cache memory has changed, the pinning engine to replace the stored data if more current data is available, and the pinning engine to selectively pin the stored data.

8. The electronic appliance of claim 7, further comprising:
the pinning engine to utilize the stored data to accelerate the launch of the application.

9. The electronic appliance of claim 8, further comprising:
the pinning engine to automatically determine which application launch to accelerate based on the frequency of previous application launches.

10. The electronic appliance of claim 8, further comprising:
the pinning engine to determine which application launch to accelerate based on a user input.

11. The electronic appliance of claim 8, wherein the cache memory comprises one from the group consisting of: processor cache, system cache, disk cache, and network cache.

12. The electronic appliance of claim 8, wherein the cache memory comprises non-volatile memory.

13. A storage medium comprising content which, when executed by an accessing machine, causes the accessing machine to store data needed for the launch of an application in a memory, to periodically determine if a starting disk address for the data has changed, and to replace the data if the starting disk address for the data has changed.

14. The storage medium of claim 13, further comprising content which, when executed by the accessing machine, causes the accessing machine to utilize the stored data to accelerate the launch of the application.

15. The storage medium of claim 14, further comprising content which, when executed by the accessing machine, causes the accessing machine to automatically determine which application launch to accelerate based on the frequency of previous application launches.

16. The storage medium of claim 14, further comprising content which, when executed by the accessing machine, causes the accessing machine to determine which application launch to accelerate based on user input.

17. The storage medium of claim 14, further comprising content which, when executed by the accessing machine, causes the accessing machine to pin the stored application launch data to prevent the stored data from being overwritten.

18. An apparatus, comprising:
cache memory;
a bus interface; and
control logic coupled with the bus interface and the cache memory, the control logic to store application launch data in the cache memory, to determine if the data is current, and to replace the stored data if more current data is available.

19. The apparatus of claim 18, further comprising control logic to automatically determine which application launch data to store based on the frequency of previous application launched.

20. The apparatus of claim 18, further comprising control logic to determine which application launch data to store based on a user input.

21. The apparatus of claim 18, further comprising control logic to pin the stored application launch data to prevent the stored data from being overwritten.

22. The apparatus of claim 18, further comprising control logic to determine if a starting disk address for the stored data has changed.
